(19) United States
(12) Patent Application Publication
(10) Pub. No.: US 2021/0195418 A1
(43) Pub. Date: Jun. 24, 2021

(54) A TECHNIQUE FOR AUTHENTICATING DATA TRANSMITTED OVER A CELLULAR NETWORK

(71) Applicant: KIGEN (UK) LIMITED, Cambridge, Cambridgeshire (GB)

(72) Inventors: Paul James REID, Ballyclare, Co. Antrim (GB); Colin Dean TEBBUTT, Cape Town, Western Cape (ZA)

(21) Appl. No.: 17/251,032

(22) PCT Filed: May 30, 2019
(86) PCT No.: PCT/GB2019/051479

§ 371 Date: Dec. 10, 2020

(30) Foreign Application Priority Data
Jun. 13, 2018 (GB) 1809696.6

(51) Int. Cl. H04W 12/06; H04W 12/61; H04L 29/06; H04W 4/60

(52) U.S. Cl. CPC H04W 12/068; H04W 12/61; H04W 4/60; H04L 63/068; H04L 63/0838; H04L 63/0807

(57) ABSTRACT

A device is arranged to comprise a communication interface (20) to transmit data over the cellular network (60) to a destination device (65). The device further has a security module (25) providing one or more security domains (32), each security domain used to host a profile facilitating access by the device to the cellular network. At least one security domain hosts a profile that stores secret data and provides a token generation application to generate a token using at least the secret data. The device then outputs the token in association with the transmitted data, enabling the destination device to perform authentication of the transmitted data by invoking an authentication service (85) that also stores the secret data (50). Such an approach provides a particularly cost effective and robust mechanism for providing a highly trusted authentication of data transmitted over a cellular network.

### BACKGROUND

The present disclosure relates to a technique for authenticating data transmitted over a cellular network.

There are many instances where a source device may need to transmit data over a cellular network to a destination device. Often, the destination device may receive data transmissions from a large number of such source devices, and often those source devices may be transmitting data autonomously without user intervention. For example, multiple devices deployed in a particular field of application may “call home” with readings and diagnostic data from sensors, where that data is sent across a cellular network to a device that is used to analyse that data.

In such deployments, it would be desirable to provide a robust mechanism that enables the device receiving the various data transmissions to trust the authenticity of those inbound communications received by it. However, an efficient and scalable mechanism is required, as it is becoming more and more common for the source devices transmitting the data to be small, low powered, devices, and for the number of such devices that may be reporting data to increase. For example, the development of “Internet of Things” (IoT) technology is allowing for the deployment of an ever increasing number of devices that can transfer data over a network without requiring human-to-human or human-to-computer interaction, and it would be desirable in such environments to provide a cost effective mechanism for allowing authentication of transmitted data.

### SUMMARY

In a first example configuration, there is provided a device comprising: a communication interface to transmit data over a cellular network to a destination device; processing circuitry to generate the data to be transmitted via the communication interface; a security module providing one or more security domains, each security domain used to host a profile, and the profile of an enabled security domain facilitating access by the device to the cellular network; at least one security domain provided by the security module hosting a profile that stores secret data and provides a token generation application that is executed within the security domain to generate a token using at least the secret data; the at least one security domain being responsive to a request from the processing circuitry to employ the token generation application to generate the token and to output the generated token to the processing circuitry; and the processing circuitry being arranged to output the token in association with the transmitted data, enabling the destination device to perform authentication of the transmitted data by invoking an authentication service that also stores the secret data.

In a further example configuration, there is provided an authentication device arranged to implement an authentication service for data transmitted to a destination device by a device in accordance with the first example configuration, the authentication device being responsive to receipt of a token transmitted with the data to the destination device to perform a token generation process to generate a compare token using at least the secret data, and to compare the compare token with the transmitted token to determine whether the transmitted data is to be treated as valid data by the destination device.

In a yet further example configuration there is provided a destination device comprising: a first interface to receive transmitted data from a device in accordance with the first example configuration; a second interface to communicate with an authentication service to request authentication of the transmitted data, the destination device being arranged to employ the second interface to forward to the authentication service the token provided in association with the transmitted data, and receive an authentication response from the authentication service; and data handling circuitry to process the transmitted data in dependence on the authentication response.

In a yet further example configuration, there is provided an integrated circuit comprising: a security module providing one or more security domains, each security domain used to host a profile, and the profile of an enabled security domain facilitating access by an associated device to a cellular network; at least one security domain provided by the security module hosting a profile that stores secret data and provides a token generation application that is executed within the security domain to generate a token using at least the secret data; and the at least one security domain being responsive to a token generation request from a requesting element to employ the token generation application to generate the token and to output the generated token to the requesting element.

In a still further example configuration, there is provided a method of authenticating transmitted data in a system where a source device transmits data over a cellular network to a destination device, the method comprising: providing the source device with a security module providing one or more security domains, each security domain used to host a profile, and the profile of an enabled security domain facilitating access by the device to the cellular network; arranging for at least one security domain provided by the security module to host a profile that stores secret data and provides a token generation application that is executed within the security domain to generate a token using at least the secret data; responsive to a request by processing circuitry of the source device, causing the at least one security domain to employ the token generation application to generate the token and to output the generated token to the processing circuitry; outputting from the source device the token in association with transmitted data generated by the processing circuitry; and causing the destination device to employ an authentication device to authenticate the transmitted data, the authentication device being responsive to receipt of the token transmitted with the data to the destination device to perform a token generation process to generate a compare token using at least the secret data, and to compare the compare token with the transmitted token to determine whether the transmitted data is to be treated as valid data by the destination device.

In a yet further example configuration there is provided a device comprising: a communication interface to transmit data over a wireless network to a destination device; processing circuitry to generate the data to be transmitted via the communication interface; and a security module providing a dedicated security domain to store secret data and to provide a token generation application that is executed within the dedicated security domain to generate a token using at least the secret data, the security module further providing a plurality of other security domains, each other security domain to host a profile, and the profile of an enabled other security domain facilitating access by the device to the wireless network; wherein: the dedicated security domain is responsive to a request from the processing circuitry to employ the token generation application to generate the token and to output the generated token to the processing circuitry, irrespective of the currently enabled other security domain; and the processing circuitry is arranged to output the token in association with the transmitted data, enabling authentication of the transmitted data to be performed.

In a yet further example configuration there is provided an authentication device to enable authentication of data transmitted by a device having a dedicated security domain, where the dedicated security domain stores secret data and provides a token generation application that is executed within the dedicated security domain to generate a token using at least the secret data, wherein the authentication device is responsive to receipt of a token transmitted with the data to perform a token generation process to generate a compare token using at least the secret data associated with the dedicated security domain, and to compare the compare token with the transmitted token to determine whether the transmitted data is to be treated as valid data.

### BRIEF DESCRIPTION OF THE DRAWINGS

The present technique will be described further, by way of illustration only, with reference to examples thereof as illustrated in the accompanying drawings, in which:

FIG. 1 is a block diagram illustrating a system in accordance with one example arrangement;

FIG. 2 is a flow diagram illustrating a setup process that may be employed within the system of FIG. 1 in order to facilitate a mechanism for authenticating transmitted data, in accordance with one example;

FIGS. 3A to 3C illustrate the use of a token mechanism to authenticate data within the system of FIG. 1, in accordance with one example arrangement; and

FIG. 4 schematically illustrates a particular implementation that may be used in one example.

### DESCRIPTION OF EXAMPLES

In one example arrangement, a device is provided that has a communication interface for transmitting data over a cellular network to a destination device, and processing circuitry for generating the data to be transmitted via the communication interface. Further, the device incorporates a security module providing one or more security domains, where each security domain is used to host a profile, and where the profile of an enabled security domain facilitates access by the device to the cellular network. Each profile may provide a collection of credentials and configuration data to enable the connection to the network. There are various known technologies for implementing a security module functionality in order to control access by the device to a cellular network. For example the security module may be implemented by a Subscriber Identity Module (SIM), which may also be referred to as a Universal Integrated Circuit Card (UICC). Whilst traditionally such security modules may be a separate smart card inserted into the device, which may for example provide a single predetermined profile, it is becoming more common for such a security module to be embedded within the device at manufacture, and to be capable of hosting multiple profiles in associated security domains. For example the security module may be an embedded UICC (eUICC) where the UICC is provided as a chip mounted onto the circuit board of a device, or an integrated UICC (iUICC) incorporated as one of the modules within a System-on-Chip (SoC).

The security requirements of such security modules are tightly defined, and indeed there are various Telecommunications Standards used to define various aspects of such security modules, including the security functionality to be provided by those modules.

In the examples described herein, the functionality of such a security module is extended so as to provide a mechanism that can be used in authenticating data transmissions over the cellular network. In particular, at least one security domain provided by the security module is arranged to host a profile that stores secret data and provides a token generation application that is executed within the security domain to generate a token using at least the secret data. Due to the fact that the token generation application is provided within such a profile, the security functionality associated with the security module allows for the token generation application to be executed within a trusted environment, hence enabling tokens to be generated by the device in a secure and trusted manner without any significant increase in the cost and complexity of the device.

Having arranged for at least one security domain of the security module to host a profile that provides the above-mentioned token generation application, then that at least one security domain can be arranged to be responsive to a request from the processing circuitry to employ the token generation application to generate the token and to output the generated token to the processing circuitry. Since the token generation application is provided by a profile within such a security domain, the existing security functionality of the security module ensures that the token generation application cannot be tampered with, and hence the processing circuitry merely makes a request for a token, and then is provided with a token generated from within the security module by the token generation application. The processing circuitry is then arranged to output the token in association with the transmitted data, enabling the destination device to perform authentication of the transmitted data by invoking an authentication service that also stores the secret data.

By such an approach, a highly robust and cost effective mechanism can be provided within the device to generate tokens in a secure manner, that can then be transmitted along with the data to the destination device to facilitate authentication procedures to be performed to authenticate the data. In particular, in one example implementation, the destination device can send a request to an authentication service to trigger generation of a compare token using the secret data and one or more items of information provided with the request, which can then be compared with the token transmitted from the originating device with the data, so that when the tokens match it can be determined that the data has been authenticated and hence can be processed by the destination device. In the absence of a matching token being generated, then instead it can be determined that authentication has failed, and the data transmitted from the originating device to the destination device may then in one example arrangement be ignored.

Whilst examples will be described herein with reference to a cellular network, the techniques described herein can be utilised in a variety of other wireless or wired networks, for example a satellite based communication network.

In one example implementation, the processing circuitry is further arranged to transmit a unique identifier in association with the transmitted data, to enable the destination device to provide the unique identifier to the authentication service along with the generated token. The authentication service can use the unique identifier to acquire its own copy of the secret data for use when generating the compare token. For example, the authentication service may be arranged to store different items of secret data, and the provision of the unique identifier can in that instance be used to enable the appropriate item of secret data to be identified, which can then be used to generate the compare token. Whilst in one implementation the unique identifier is transmitted with the transmitted data, in other implementations this may not be necessary and instead the destination device and/or authentication service may be able to derive the unique identifier based on other data/metadata present in the received payload.

The unique identifier can take a variety of forms, but in one example implementation is an identifier for the profile that generated the token. The one or more profiles that are hosted by corresponding security domains within the security module can be managed in a variety of ways, but in one example implementation each profile is associated with a mobile network operator that controls the content of that profile. Hence, by way of example, a number of different profiles can be stored on the security module, in associated security domains, where each of those profiles is associated with a different mobile network operator. One or more of those profiles may also be arranged to provide a token generation application and to store secret data, or alternatively a separate dedicated profile can be provided for that purpose.

In one example implementation, each profile is downloadable to an associated security domain within the security module under control of a Subscription Management Platform managed by a mobile network operator. Hence, this allows for reconfigurability of the security module, since profiles can be downloaded to the security module as and when required, to take account of the cellular network(s) being used by the device.

In one example implementation, the token generation application is downloaded as part of the download process for a profile that provides the token generation application.

The secret data used by the token generation application, and by the authentication service, can take a variety of forms. However, in one example implementation, when the profile being downloaded is a profile that provides the token generation application, a key generated during a download procedure employed to download that profile is used as the secret data, and the key is provided by the Subscription Management Platform to the authentication service. In particular, when employing known techniques for downloading profiles, a secure channel may be established for that purpose and as a by-product of that secure download process, a key may be generated, and that same key can be re-purposed for use by the token generation application and the authentication service.

However, it is not a requirement for the secret data to be generated in such a way. For example, in an alternative implementation, the secret data may be dedicated secret data generated specifically for use by the token generation application, and the secret data is provided to the authentication service at least prior to the profile being enabled for use on the device. The time at which the secret data is provided to the authentication service in such a situation can be varied, as long as the authentication service has knowledge of the secret data prior to the profile being enabled for use on the device. However, in one example implementation, where the profile is to be downloaded on to the security module, the dedicated secret data may be provided to the authentication service prior to the download of the profile to the device, thereby ensuring that the secret data is available to the authentication service before the token generation application can be used to generate a token using the secret data.

The secret data can take a variety of forms, but in one example implementation is a symmetric key that is shared between the profile that provides the token generation application, and the authentication service that generates the compare token.

In one example implementation, the token generation application that is executed within the security domain is arranged to generate the token using the secret data and a timestamp (which may also be referred to as a time counter). There are a number of suitable algorithms that can be used to generate the token using this information, but in one example implementation a Time-based One-Time Password (TOTP) algorithm is used, where both the device generating the token and the authentication device used to authenticate the token have access to a trusted time source. As another example, rather than relying on a trusted time source, an event-based OTP, also called HOTP (HMAC-based One-Time Password, where HMAC stands for Hash-based message authentication), algorithm can be used. In such an approach, counters are kept in both the device generating the token and the authentication device used to authenticate the token, and the incrementing of the counters in both devices are managed so as to ensure the counters remain synchronised.

In one implementation, the timestamp used by the token generation application could also be output to the destination device along with the token. However, in an alternative implementation, the processing circuitry does not transmit the timestamp with the transmitted data, and the authentication service is arranged to make an assumption about the timestamp. In particular, the timestamp mechanism may operate with a particular level of granularity, and hence based on the timing of receipt of the transmitted data, a sensible assumption may be able to be made about the timestamp that was used by the source device. In one particular implementation, it may be known that the timestamp could only be one of a relatively small number of possible values, and accordingly if desired the compare token may be generated for each of those possible timestamp values, to see if any of those compare tokens then match the original token generated by the source device. By such an approach, this avoids the need to transmit timestamp information over the cellular network, which not only reduces bandwidth requirements, but may further improve security.

In one example implementation, the token generation application and associated secret data can be provided within any profile where it is desired to facilitate implementation of the data authentication process described earlier. As a result, it may be that some mobile operators support the authentication process while others do not. Alternatively, a dedicated security domain may be arranged to host the profile that stores the secret data and provides the token generation application (or indeed the dedicated security domain may store the secret data and provide the token generation application but not host a profile), and a plurality of other security domains are provided to host subscription profiles associated with different mobile network operators, wherein the token generation algorithm is referenced when a request for a token is received from the processing circuitry, irrespective of the currently enabled subscription profile. In this latter case, a number of different subscription profiles can be downloaded to the security module, with any one of those subscription profiles being enabled at any particular point in time, and then irrespective of the enabled subscription profile, the dedicated security domain can be used when it is necessary to generate a token for data being transmitted from the device.

There are a number of ways in which the token can be transmitted with the data so that authentication of that data can then later be performed using the token. In one particular implementation the token is provided in an authentication header associated with the transmitted data. Hence, for example, the transmitted data can be arranged in packets, with each packet having an associated header, and the header can include the token information to enable the data within the packet to be authenticated.

The authentication device used to implement the authentication service can take a variety of forms. However, in one example arrangement the authentication device is responsive to receipt of a token transmitted with the data to the destination device (this for example being provided via an authentication request from the destination device) to perform a token generation process to generate a compare token using at least the secret data, and to compare the compare token with the transmitted token to determine whether the transmitted data is to be treated as valid data by the destination device.

In one example implementation, an indication of a unique identifier is provided to the authentication device with the transmitted token, and the authentication device maintains a record of the secret data associated with a number of unique identifiers. As a result, when performing the token generation process, the record may be referenced in order to obtain the secret data for the unique identifier associated with the transmitted token. By such an approach, the authentication device can maintain items of secret data for a number of different unique identifiers, and then determine the appropriate item of secret data to use for any particular authentication request received, dependent on the unique identifier provided with that authentication request.

In one example implementation, the authentication device is arranged to apply an identical token generation algorithm to that used by the token generation application executed within a security domain of the security module of the source device that generated the original token that now needs to be checked.

As mentioned earlier, the timestamp used to generate the original token can also be propagated on to the authentication device if desired. However, in one example implementation, when performing the token generation process an assumption is made about a timestamp value employed by the source device when the transmitted token was generated.

If desired, the token generation process employed by the authentication device can be repeated for a number of possible timestamp values, so as to take account of a number of possible timestamp values that may have been used by the source device at the time the original token was generated. Then, if no match is detected between the transmitted token and one of the generated compare tokens, the authentication device may be arranged to indicate that the transmitted data is to be treated as invalid data by the destination device. The action taken by the destination device when it is informed that the data is invalid can vary dependent on implementation. However, in some example implementations, it may merely be the case that the data is discarded at that point by the destination device, and not processed further.

Whilst in principle the authentication device may be incorporated within the destination device itself, in other example implementations the authentication device is a separate entity to the destination device, allowing the authentication device to provide authentication services for a number of different destination devices.

The destination device can be arranged in a variety of ways. In one example implementation the destination device has a first interface for receiving transmitted data from a source device, and a second interface to communicate with an authentication service to request authentication of the transmitted data. The destination device is arranged to employ the second interface to forward to the authentication service the token provided in association with the transmitted data, and to receive an authentication response from the authentication service. Data handling circuitry within the destination device is then used to process the transmitted data in dependence on the authentication response. For example, it may be arranged to discard any transmitted data for which the authentication response indicates that the authentication has failed, and to only actively process transmitted data for which the authentication response indicates that authentication has been passed. It should be noted that whilst the first and second interfaces may be arranged as physically separate interfaces, they can alternatively be provided by the same physical interface.

How the destination device responds to an authentication response that indicates that the data is invalid can be varied dependent on implementation. Whilst in principle the source device could be notified of such a failure, it may often be the case that the source device is not notified, and instead the transmitted data is merely discarded.

However, if desired, the destination device may further comprise log storage to maintain a log providing information about instances where transmitted data was treated as invalid based on the authentication response. This enables, for example, statistical data to be obtained over time about the level of authentication failure within the system.

In one example scenario, the destination device may then further comprise alert generation circuitry to issue an alert signal in dependence on the information held in the log storage, and hence for example could generate an alert when it is determined that the level of authentication failure observed is above a particular threshold.

The security module can be provided in a variety of ways, but in one example implementation an integrated circuit is provided that comprises a security module providing one or more security domains, each security domain used to host a profile, and the profile of an enabled security domain facilitating access by an associated device to a cellular network. At least one security domain provided by the security module is arranged to host a profile that stores secret data and provides a token generation application that is executed within the security domain to generate a token using at least the secret data. The at least one security domain is responsive to a token generation request from a requesting element to employ the token generation application to generate the token and to output the generated token to the requesting element. The integrated circuit could be arranged to solely provide the security module, with that integrated circuit then being mounted on a printed circuit providing other components of the device, or alternatively the integrated circuit could be a System-on-Chip (SoC) providing additional components of the device as well as the security module.

In one example configuration a device having a communication interface and processing circuitry as discussed earlier is arranged such that its security module provides a dedicated security domain to store secret data and to provide a token generation application that is executed within the dedicated security domain to generate a token using at least the secret data. The security module further provides a plurality of other security domains, each other security domain to host a profile, and the profile of an enabled other security domain facilitating access by the device to the cellular network. The dedicated security domain is responsive to a request from the processing circuitry to employ the token generation application to generate the token and to output the generated token to the processing circuitry, irrespective of the currently enabled other security domain. The processing circuitry is arranged to output the token in association with the transmitted data, enabling authentication of the transmitted data to be performed.

By such an approach, a mechanism may be provided to enable the token generation mechanism described herein to be employed irrespective of which subscription profile is enabled, without needing to replicate the token generation application and secret data within each of the security domains that host subscription profiles.

There are a number of ways in which the token generation application can be provided within the dedicated security domain. In one example arrangement, the token generation application may be downloadable to the dedicated security domain under control of a suitable entity within the system. For example the Subscription Management Platform may control the download of the token generation application to the dedicated security domain.

In addition, or alternatively, the secret data may be downloadable to the dedicated security domain. The secret data used by the token generation application, and by the authentication service, can take a variety of forms. However, in one example implementation, when the token generation application is being downloaded, a key generated during a download procedure employed to download that token generation application is used as the secret data, and the key is also provided to the authentication service. In particular, a secure channel may be established for performing the download of the token generation application. As a by-product of that secure download process, a key may be generated, and that same key can be re-purposed for use by the token generation application and the authentication service. Alternatively the secure data may be generated entirely separately to the key used for the download process, and provided to both the dedicated security domain of the device and to the authentication service.

In one example arrangement, the security module further comprises a profile control element to control which of the plurality of other security domains is the enabled other security domain. For example the profile control element may take the form of an ISD-R (Issuer Security Domain Root) element that is arranged to communicate with a corresponding off-card entity SM-SR (Subscription Manager Secure Routing) element. Each other security domain may then be provided by an ISD-P (Issuer Security Domain Profile) element. Under instruction from the SM-SR, the ISD-R may then control which other security domain is the enabled other security domain. It should be noted that the dedicated security domain is treated differently to the other security domains and is not available for selection by the ISD-R during the above process. Instead, the dedicated security domain may be arranged to continue to service each request from the processing circuitry for a token, irrespective of any change to the enabled other security domain made by the profile control element.

The dedicated security domain can take a variety of forms but in one example implementation comprises an Issuer Security Domain Applet (ISD-A) element, and does not host a profile (in contrast to the ISD-P elements). The ISD-A element is a security domain dedicated to applets. Rather than applets needing to be provided within individual ISD-Ps, the use of the ISD-A element enables applets to be promoted so that they are no longer dependent on an ISD-P.

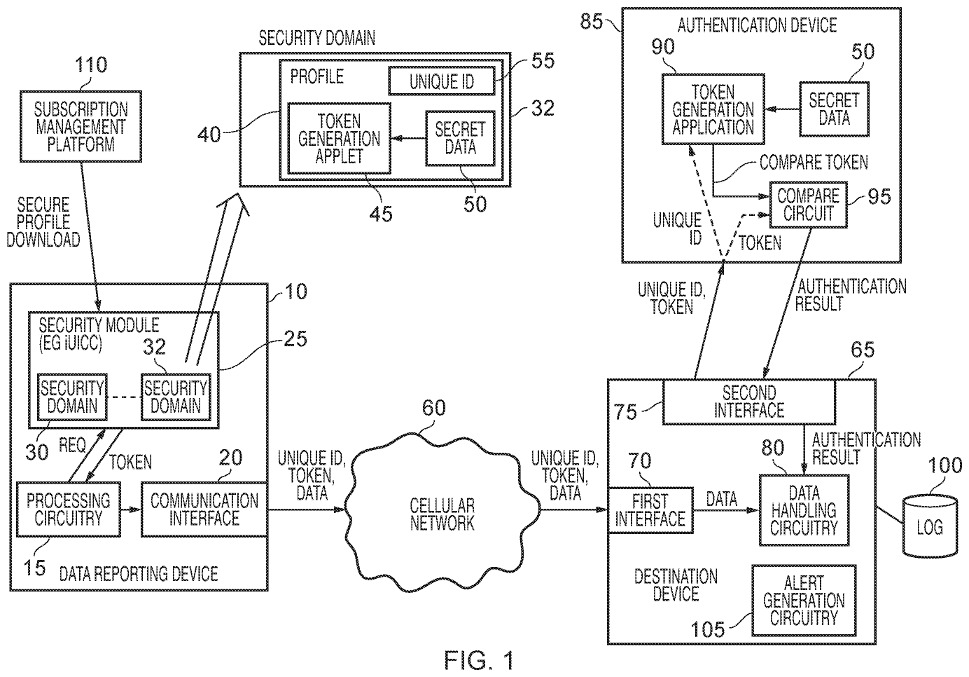

Particular examples will now be described with reference to the Figures. FIG. 1 is a block diagram of a system in accordance with one example implementation. A data reporting device 10 is provided that is arranged to periodically send data over a cellular network 60 to a destination device 65. The data transmitted may take a variety of forms, for example readings relating to a meter provided in association with the data reporting device 10, diagnostic data from sensors associated with the data reporting device, etc.

The data reporting device 10 has processing circuitry 15 for performing various processing operations, including generation of the data to be transmitted over the cellular network, the processing circuitry 15 being coupled to a communication interface 20 via which the data is transmitted onto the cellular network 60.

A security module 25 is provided within the data reporting device, taking for example the form of a UICC, such as an eUICC or iUICC. The security module 25 will in one implementation be of a form that is strictly managed by one or more Telecommunications Standards applicable to the cellular network 60. For example, the organisation and structure of the security module may be defined by GSMA Standards. As provided for by such Standards, the security module can include one or more security domains 30, 32 which provide secure environments for associated profiles provided within those security domains. Typically, at any point in time, one of the security domains will be enabled, and the associated profile can be used to control access by the device to the cellular network.

When using a reconfigurable UICC such as an eUICC or an iUICC, a subscription management platform 110 may be arranged to download profiles in a secure manner to associated security domains 30, 32 provided within the security module. The individual profiles may for example relate to different mobile network operators, so that when the device connects to a particular cellular network, the appropriate profile can be enabled to control communication over that cellular network 60. As with the security module 25 itself, the manner in which profiles are downloaded to the security module may be tightly controlled in accordance with one or more

Telecommunications Standards. For example, in one implementation, the downloading of profiles in a secure manner from the subscription management platform 110 is controlled by the GSMA Official Document SGP.02—“Remote Provisioning Architecture for Embedded UICC Technical Specification”.

In accordance with one technique described herein, at least one of the profiles provided within the security module 25 includes a token generation applet for generating a token based on associated secret data. In the example shown in FIG. 1, it is assumed that at least the security domain 32 provides a profile of that form, in particular the profile 40 shown in FIG. 1. Hence, the profile includes a token generation applet 45 that is arranged to generate a token based on secret data 50 also provided within the profile. The profile 40 also has a unique identifier 55, the unique identifier in one implementation being an ID uniquely allocated to the profile 40. The token can be generated using a number of possible algorithms, but in one particular example a Time-based One-Time Password (TOTP) algorithm is used to generate the token using the secret data 50 and a timestamp value generated from timestamp generation logic within the device 10.

The secret data 50 can take a variety of forms, but is also shared with an authentication device 85. In one particular implementation, the secret data takes the form of a symmetric key used by both the token generation applet 45 within the profile 40 and a token generation application 90 within the authentication device 85.

When the processing circuitry 15 determines that there is data to be reported to the destination device 65, it may be arranged to send a token generation request to the security module 25. Assuming token generation is enabled for the particular cellular network 60 being used, then the appropriate profile will include the token generation applet, and will respond to the request by performing the token generation process in order to generate a token which is then returned to the processing circuitry. As mentioned earlier, the token will be generated based on the secret data maintained within the profile and a timestamp value. If token generation is not enabled for the particular cellular network, then the processing circuitry may be arranged not to send a token generation request, but in the event a token generation request is sent an error signal may be raised.

In an alternative arrangement a dedicated security domain may be used to store the token generation applet and associated secret data, but may not itself provide a profile. By such an approach, the token generation mechanism can be used irrespective of the enabled profile, and there is no need to replicate the token generation application and secret data within each of the security domains that host subscription profiles.

Once the token has been returned, the processing circuitry can then form a transmission block of information to be output over the cellular network. The transmission block can take a variety of forms, but may for example include one or more packets. The transmission block will include the data to be transmitted, but will also include the token provided by the security module 25 and the relevant unique identifier. In particular, that unique identifier can be returned from the security module to the processing circuitry along with the token, for provision within the output transmission block. The token and unique identifier information can be included within the transmission block in a variety of ways, but in one particular implementation may be included within header information.

Whilst in the described implementation the unique identifier is transmitted with the token, in other implementations this may not be necessary and instead the destination device 65 and/or authentication device 85 may be able to derive the unique identifier based on other data/metadata present in the received payload/transmission block. The destination device 65 is arranged to receive the transmission block at a first interface 70. Upon receipt, the unique identifier and token information will then be extracted and output via a second interface 75 to the authentication device 85 as part of an authentication request. It should be noted that whilst the first and second interfaces may be arranged as physically separate interfaces, they can alternatively be provided by the same physical interface.

Typically, the authentication device may be arranged to provide authentication services in respect of a number of different profiles, and accordingly will maintain secret data applicable to each profile. Based on the unique identifier provided with the authentication request, the appropriate secret data can be determined, and then that secret data can be used by the token generation application 90 to generate a compare token.

Where a dedicated security domain is used to provide the token generation applet, the secret data may not be dependent on the currently enabled profile, and in one such example implementation the unique identifier transmitted with the token will be a unique identifier for the dedicated security domain rather than a unique identifier for the currently enabled profile. Hence, the authentication device can use the unique identifier for the dedicated security domain to determine the secret data to be used when generating the compare token.

Alternatively, if different secret data is used for each profile, the dedicated security domain may be arranged to store each possible secret data and then choose the appropriate secret data to use dependent on the enabled profile at the time the token generation request was received. In such an implementation, the unique identifier for the currently enabled profile can be transmitted with the token to enable the authentication device to determine the appropriate secret data to use when generating the compare token.

As will be discussed in more detail later, the timestamp value used by the token generation applet 45 at the data reporting device 10 when generating the original token can also be provided within the transmission block for forwarding to the authentication device 85, but alternatively the authentication device may make some assumption about the timestamp value when generating the compare token.

For instance, depending on the timestamp mechanism used, this may determine whether an indication of the timestamp is to be propagated on to the destination device with the token or not. For example, considering the generation of the token within a standalone standard eSIM, only a rough estimate of the current time may be possible, based upon certificates/certificate revocation lists which have been verified previously. In such a case, substantial drift may be possible between the views of the current time held by the token generation applet 45 and the token generation application 90 in the authentication device 85. Hence, to aid generation of an appropriate “compare token”, the timestamp used to generate the token in the applet 45 may be transmitted along with the token and the unique identifier for onward propagation to the authentication device 85.

As another example, considering generation of the token within an iSIM, the applet 45 (hosted for example in a secure zone on chip) may have an interface to a secure, reliable, real-time clock running in the SoC in which it is integrated. In this case, transmission of the timestamp for provision to the authentication device 85 may not be necessary, and instead the authentication device 85 may be able to make assumptions about the timestamp value used during generation of the token.

Once the compare token has been generated, a compare circuit 95 then compares the originally generated token with the compare token and, based on that comparison, issues an authentication result back to the second interface 75. The data handling circuitry 80 within the destination device 65 can then determine how to handle the data dependent on the authentication result. For example, it may only continue to process data where the authentication result indicates that authentication has been passed, and in one example implementation could be arranged to merely discard any data for which the associated authentication result indicates that authentication has failed.

In one implementation, a log 100 can be used to keep information about authentication failure that has arisen during operation. For example this could merely be a historical indication of the level of authentication failure occurring within the system. Alert generation circuitry 105 can then be arranged to monitor the contents of the log and, upon detecting one or more alert criteria with reference to the contents of the log, can then be arranged to issue an alert signal, for example to trigger a review of the log 100 by an operator. Whilst in principle detection of an authentication failure could be reported back to the data reporting device 10, in many scenarios this will not be considered appropriate. For example, in many deployment situations, the data reporting devices 10 may be small, low powered, devices having relatively limited functionality, for example functionality sufficient to enable the reporting of the required data over the cellular network to the destination device. For instance, the data reporting device could be a simple IoT device used for that purpose, and the destination device may be an IoT management system used to process the data provided by a large number of separate IoT devices.

The data handling circuitry 80 may be arranged to perform active processing of the data, or alternatively may merely collate data from transmissions that have been authenticated, for onward transmission to another device for analysis. For example, in a smart meter implementation where each of the data reporting devices is a smart meter such as may be used by certain electricity companies, then the destination device may simply perform an initial data gathering function in relation to legitimate transmitted data as authenticated by the authentication device, with that data then being propagated onto a server within the smart meter company for further processing. Alternatively, the destination device may be incorporated within such a smart meter server.

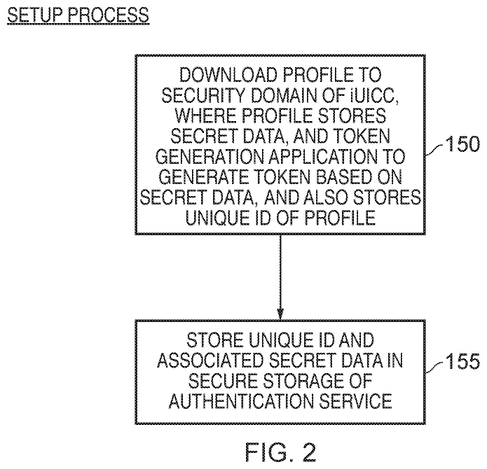

FIG. 2 is a flow diagram illustrating a setup process that may be performed within the system of FIG. 1 to enable the token-based data authentication process. At step 150, a profile may be downloaded to a security domain of the iUICC 25, using for example the subscription management platform 110, where that profile stores secret data, and provides a token generation application used to generate a token based on that secret data. A unique identifier of the profile is also stored within the profile. In addition, at step 155, the unique identifier of that profile and the associated secret data may be stored within a secure storage of the authentication service device 85. Thereafter, once the profile is enabled for use within the device 10, the profile can be used to generate tokens upon request by the processing circuitry, for onward transmission with associated data to the destination device, whereafter an authentication process can be performed by the authentication device 85 in order to determine whether the transmitted data is authenticated or not.

As mentioned earlier, in an alternative implementation a dedicated security domain may be used to store the token generation applet and associated secret data, but may not itself provide a profile. By such an approach, the token generation mechanism can be used irrespective of the enabled profile, and there is no need to replicate the token generation application and secret data within each of the security domains that host subscription profiles.

The secret data shared between the token generation applet of a profile executed within one of the security domains of the security module 25, and the token generation application 90 running on the authentication device 85, can be generated in a variety of ways. For example, that secret data (which in one implementation may take the form of a symmetric key) can be generated explicitly for use by the profile, and may be passed to the authentication device 85 for storage therein prior to downloading the profile to the security module 25. However, in an alternative arrangement, the secret data may be a key that is generated as a by-product of the profile download process. For example, the secret data could be derived using SCP03 keys that are generated as a by-product of creating a new profile via the DownloadProfile procedure as specified in the earlier-mentioned GSMA Spec SGP.02. In particular, in this latter case, the keys are established via an Elliptic Curve Based Key Agreement process. In that event, the key again would be provided to the authentication service, and in such an environment the authentication service could be provided as a value added service (VAS) deployed along with a standard server used to manage the download of profiles (an SM-DP (Subscription Manager Data Preparation) server as described in the SGP.02 specification).

In implementations where a dedicated security domain is used to provide the token generation application, the secret data may not be linked to a particular profile, and instead there may be a single item of secret data for the dedicated security domain. As discussed earlier, in such an implementation, the unique identifier transmitted with the token will be a unique identifier for the dedicated security domain rather than a unique identifier for the currently enabled profile, and the authentication device can use the unique identifier for the dedicated security domain to determine the secret data to be used when generating the compare token.

Alternatively the dedicated security domain may store multiple items of secret data, and at the time a token generation request is received, an item of secret data associated with the currently enabled profile may be chosen for use in the token generation operation. In such an implementation, the unique identifier for the currently enabled profile can be transmitted with the token to enable the authentication device to determine the appropriate secret data to use when generating the compare token.

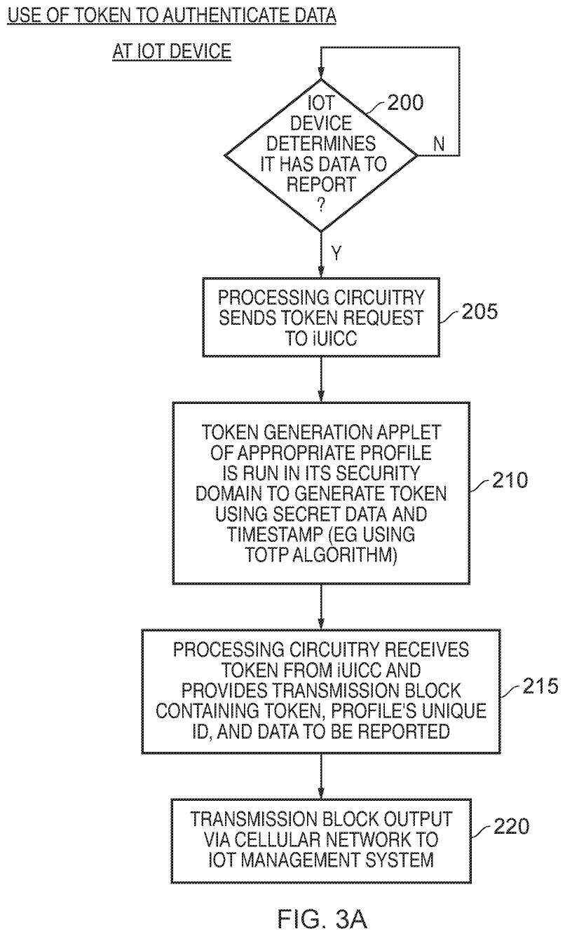

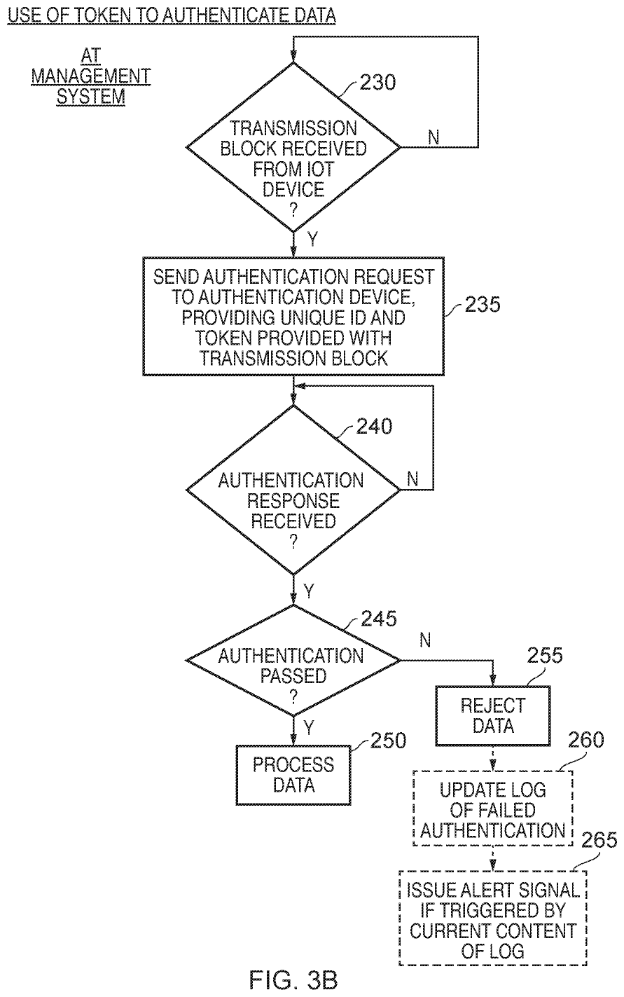

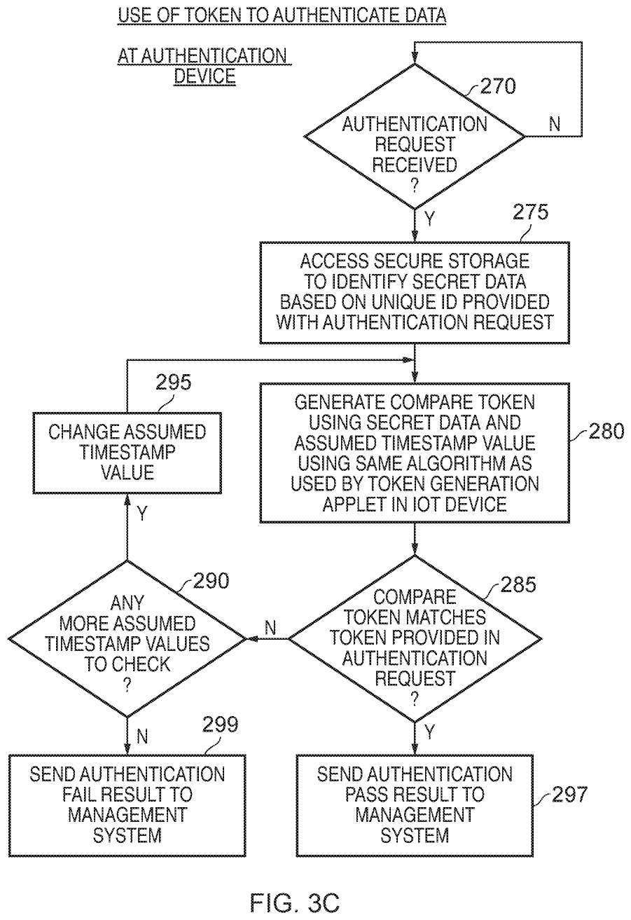

FIGS. 3A to 3C are flow diagrams illustrating the use of a token within the system of FIG. 1 in order to authenticate data in accordance with one example implementation. At step 200, it is determined whether the IoT device 10 has data to report, and when it does the process proceeds to step 205 where the processing circuitry 15 sends a token generation request to the iUICC.

Thereafter, at step 210, the token generation applet 45 of the appropriate profile is run within its security domain in order to generate a token using the secret data 50 and a timestamp value, using any suitable token generation algorithm, for example the earlier-mentioned TOTP algorithm.

At step 215, the processing circuitry receives the token from the iUICC and produces a transmission block containing the token, the profile's unique identifier and the data to be reported. Thereafter, at step 220, the transmission block is output from the communication interface 20 via the cellular network 60 to the IoT management system 65.

FIG. 3B illustrates the process performed at the management system 65. At step 230, the management system awaits receipt of a transmission block from the IoT device, whereafter the process proceeds to step 235 where an authentication request is sent from the management system 65 to the authentication device 85, that request providing the unique identifier and the token provided with the transmission block. At step 240, the management system then awaits an authentication response, and when received it is then determined from the authentication response at step 245 whether authentication has been passed or failed. If authentication has been passed, then the process proceeds to step 250, where the data handling circuitry 80 processes the received data. However, if authentication is determined at step 245 to have failed, then at step 255 the data is rejected. In one example implementation it may be sufficient at this stage to merely discard the received data.

As indicated by the optional steps 260, 265, if desired a log of failed authentication requests can be maintained, and at step 260 that log may be updated to take account of the latest authentication failure. At step 265, the alert generation circuitry may analyse the contents of the log and issue an alert signal if the current content of the log indicates a trigger condition for generating such an alert. The alert can be used in a variety of ways, but in one implementation may be sent to an operator of the management system, to bring attention to the trigger condition, and cause the operator to undertake a further analysis of the log 100. This may for example be used to detect situations where one or more of the data reporting devices are faulty.

FIG. 3C illustrates the steps that may be performed at the authentication device 85. At step 270, the authentication device awaits receipt of an authentication request, and when received the process then proceeds to step 275 where secure storage within the authentication device is accessed based on the unique identifier provided with the authentication request, in order to identify the associated secret data.

The process then proceeds to step 280 where a compare token is generated by the token generation application 90 using the identified secret data and an assumed timestamp value. In the illustrated example, the same algorithm is used by the token generation application 90 as was used by the token generation applet 45 in the IoT device 10.

At step 285 it is determined whether the compare token matches the token provided in the authentication request. If so, then an authentication pass result can be returned to the management system 65 at step 297. However, if the compare token does not match, then at step 290 it is determined whether there are any more assumed timestamp values to be checked. In particular, the timestamp values may change with a relatively coarse granularity, and hence based on the timing of receipt of the authentication request, it may be assumed that the timestamp value used when the token was originally generated could only be one of a relatively small number of possible values, and it may be appropriate to generate compare tokens for all of those potential values.

Hence, if there are any more assumed timestamp values to check, the process proceeds to step 295 where the assumed timestamp value is changed, and then the process proceeds to step 280.

Whilst in FIG. 3C the compare tokens are generated sequentially based on the potential timestamp values, it will be appreciated that in an alternative implementation all of the possible compare tokens may be generated at one time and then compared with the token provided in the authentication request.

If it is determined at step 290 that the comparison process has been performed for all of the possible timestamp values and no match has been detected, then the process proceeds to step 299 where an authentication fail result is reported back to the management system 65.

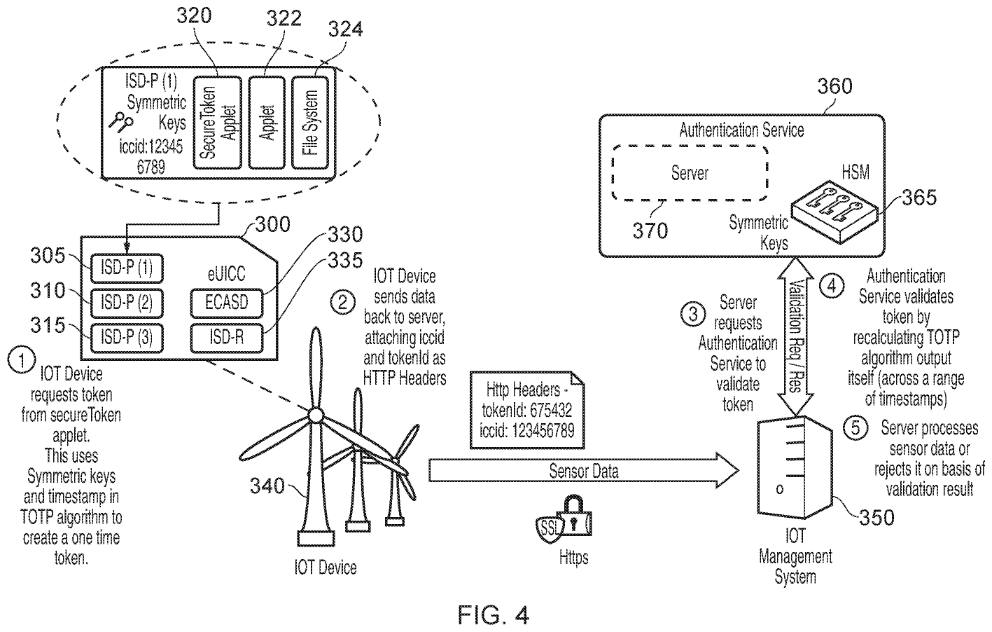

FIG. 4 schematically illustrates a specific example implementation. In this example, an IoT device 340, such as a small reporting device deployed on a wind turbine, incorporates an eUICC 300 acting as a security module. That eUICC can be arranged to provide one or more ISD-P (Issuer Security Domain Profile) elements, each ISD-P hosting a unique profile in an associated secure domain. In this example, it is assumed that at least one of the ISD-P elements 305, 310, 315 hosts a profile that provides a secure token applet 320, and stores an associated one or more symmetric keys. As shown in FIG. 4, other functionality may also be provided as part of the profile, through the provision of one or more further applets 322, and also a file system 324 may be provided as per the standard arrangement of an ISD-P. Hence, it can be seen that the standard ISD-P functionality is extended through the provision of a secure token applet 320 and an associated symmetric key for use in generating tokens. The “iccid” is a unique ID for the profile maintained by the ISD-P. Typically, only one ISD-P will be enabled any point in time, and different ISD-P elements may be provided for each possible cellular network provider that the device may connect to.

Whilst in FIG. 4, the secure token applet is provided in one or more of the ISD-P elements downloaded under the control of particular mobile network operators, in an alternative implementation a dedicated security domain may be provided for hosting a profile that provides the secure token applet and associated symmetric key (or for providing the secure token applet and associated symmetric key without hosting a profile), so that the secure token applet provided by that dedicated security domain is always used to handle a request for a token, irrespective of the currently enabled subscription profile maintained by the enabled ISD-P.

The ISD-R (Issuer Security Domain Root) element 335 is arranged to communicate with the corresponding off-card entity SM-SR (Subscription Manager Secure Routing) element, and is used as part of the subscription management system to download profiles to the device. The ISD-R will for example create a new ISD-P when a new profile is to be downloaded. If a dedicated security module is employed as discussed earlier, then the ISD-R may also be involved in the creation of that dedicated security module, for example by being involved in the download process used to provide the token generation application within that dedicated security domain. However, once the dedicated security domain has been created, that dedicated security domain may be addressed directly by the processing circuitry/operating system without involvement of the ISD-R.

The ECASD (eUICC Controlling Authority Security Domain) element 330 is arranged to establish a trust route with the subscription management platform 110, and can be used to authenticate profiles being downloaded from the subscription management platform 110. One of its functions is to establish key sets during the profile download process.

As shown in FIG. 4, when the IoT device incorporating the eUICC 300 requests a token from the secure token applet, the symmetric key and timestamp information are employed to generate a onetime token using the secure token applet 320.

Once the token has been returned, then the IoT device sends the data back to the IoT management system 350, attaching the iccid and token information to the transmitted data. In the example shown, this information is included within the HTTP headers.

Upon receipt of the transmitted block of data, the management system server 350 requests the authentication service 360 to validate the token. The authentication service can be provided by a server 370 with an associated Hardware Security Module (HSM) 365 to store the symmetric keys.

The authentication service 360 then validates the token by recalculating a compare token using the TOTP algorithm. As discussed earlier, this can be performed across a range of timestamps, and each compare token generated is compared with the original token received with the data. In the event of a match, the management system server 350 may then process the sensor data, but otherwise will reject the received data.

In accordance with the technique described above, secure token generation within a data reporting device is achieved by providing a secure token applet within a security domain of a security module such as a UICC. By exercising a security domain within a UICC for this purpose, best of breed, Standards compliant, security can be assured on the data reporting device. This hence provides a very robust and cost effective mechanism for providing secure token generation at the data reporting device, which then facilitates use of an authentication process by the destination device in response to received data, in order to authenticate the data prior to processing of that data.

Further, the described techniques for generating the symmetric keys will confer the assurance of GSMA SAS (Security Accreditation Scheme) certified context to the authentication service provided by the authentication device 85.

Furthermore, the solution is highly portable, in that the required secure token applet can be provisioned onto security modules from any vendor.

The techniques described herein can be used in a wide variety of different situations where data reporting devices will be providing data to a destination device. For example, the described approach provides a robust and cost-effective mechanism to allow servers that manage IoT devices to trust the authenticity of inbound communications coming from those IoT devices.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. A device comprising:
a communication interface to transmit data over a cellular network to a destination device;
processing circuitry to generate the data to be transmitted via the communication interface;
a security module providing one or more security domains, each security domain used to host a profile, and the profile of an enabled security domain facilitating access by the device to the cellular network;
at least one security domain provided by the security module hosting a profile that stores secret data and provides a token generation application that is executed within the security domain to generate a token using at least the secret data;
the at least one security domain being responsive to a request from the processing circuitry to employ the token generation application to generate the token and to output the generated token to the processing circuitry; and
the processing circuitry being arranged to output the token in association with the transmitted data, enabling the destination device to perform authentication of the transmitted data by invoking an authentication service that also stores the secret data.

2. A device as claimed in claim 1, wherein the processing circuitry is further arranged to transmit a unique identifier in association with the transmitted data, to enable the destination device to provide the unique identifier to the authentication service along with the generated token.

3. A device as claimed in claim 1, wherein the unique identifier is an identifier for the profile that generated the token.

4. A device as claimed in claim 1, wherein each profile is associated with a mobile network operator that controls the content of that profile.

5. A device as claimed in claim 1, wherein the security module is one of an embedded universal integrated-circuit card (eUICC) and an integrated UICC (iUICC) capable of storing a plurality of profiles.

6. A device as claimed in claim 5, wherein each profile is downloadable to an associated security domain within the security module under control of a Subscription Management Platform managed by a mobile network operator.

7. A device as claimed in claim 6, wherein the token generation application is downloaded as part of the download process for a profile that provides the token generation application.

8. A device as claimed in claim 6, wherein when the profile being downloaded is a profile that provides the token generation application, a key generated during a download procedure employed to download that profile is used as the secret data, and the key is provided by the Subscription Management Platform to the authentication service.

9. A device as claimed in claim 1, wherein the secret data is dedicated secret data generated specifically for use by the token generation application, and the secret data is provided to the authentication service at least prior to the profile being enabled for use on the device.

10. A device as claimed in claim 1, wherein the secret data is a symmetric key.

11. A device as claimed in claim 1, wherein the token generation application that is executed within the security domain is arranged to generate the token using the secret data and a timestamp.

12. A device as claimed in claim 11, wherein the token generation application is arranged to employ one of a Time-based One-Time Password (TOTP) algorithm and an event-based One-Time Password algorithm.

13. A device as claimed in claim 11, wherein the processing circuitry does not transmit the timestamp with the transmitted data, and the authentication service is arranged to make an assumption about the timestamp.

14. A device as claimed in claim 1, wherein a dedicated security domain is arranged to host the profile that stores the secret data and provides the token generation application, and a plurality of other security domains are provided to host subscription profiles associated with different mobile network operators, wherein the profile that provides the token generation algorithm is referenced when a request for a token is received from the processing circuitry, irrespective of the currently enabled subscription profile.

15. A device as claimed in claim 1, wherein the token is provided in an authentication header associated with the transmitted data.

16. An authentication device arranged to implement an authentication service for data transmitted to a destination device by a device as claimed in claim 1, the authentication device being responsive to receipt of a token transmitted with the data to the destination device to perform a token generation process to generate a compare token using at least the secret data, and to compare the compare token with the transmitted token to determine whether the transmitted data is to be treated as valid data by the destination device.

17. An authentication device as claimed in claim 16, wherein an indication of a unique identifier is provided to the authentication device with the transmitted token, and the authentication device maintains a record of the secret data associated with a number of unique identifiers, wherein when performing the token generation process the record is referenced in order to obtain the secret data for the unique identifier associated with the transmitted token.

18. An authentication device as claimed in claim 16, wherein the authentication device is arranged to apply an identical token generation algorithm to that used by the token generation application executed within a security domain of the security module of the device.

19. An authentication device as claimed in claim 16, wherein when performing the token generation process an assumption is made about a timestamp value employed by the device when the transmitted token was generated.

20. An authentication device as claimed in claim 19, wherein the token generation process is repeated for a number of possible timestamp values, and when no match is detected between the transmitted token and one of the generated compare tokens the authentication device is arranged to indicate that the transmitted data is to be treated as invalid data by the destination device.

21. An authentication device as claimed in claim 16, wherein the authentication device is incorporated within the destination device.

22. A destination device comprising:
a first interface to receive transmitted data from a device as claimed in claim 1;
a second interface to communicate with an authentication service to request authentication of the transmitted data, the destination device being arranged to employ the second interface to forward to the authentication service the token provided in association with the transmitted data, and receive an authentication response from the authentication service; and
data handling circuitry to process the transmitted data in dependence on the authentication response.

23. A destination device as claimed in claim 22, further comprising log storage to maintain a log providing information about instances where transmitted data was treated as invalid based on the authentication response.

24. A destination device as claimed in claim 23, further comprising alert generation circuitry to issue an alert signal in dependence on the information held in the log storage.

25. An integrated circuit comprising:
a security module providing one or more security domains, each security domain used to host a profile, and the profile of an enabled security domain facilitating access by an associated device to a cellular network;
at least one security domain provided by the security module hosting a profile that stores secret data and provides a token generation application that is executed within the security domain to generate a token using at least the secret data; and
the at least one security domain being responsive to a token generation request from a requesting element to employ the token generation application to generate the token and to output the generated token to the requesting element.

26. A method of authenticating transmitted data in a system where a source device transmits data over a cellular network to a destination device, the method comprising:
providing the source device with a security module providing one or more security domains, each security domain used to host a profile, and the profile of an enabled security domain facilitating access by the device to the cellular network;
arranging for at least one security domain provided by the security module to host a profile that stores secret data and provides a token generation application that is executed within the security domain to generate a token using at least the secret data;
responsive to a request by processing circuitry of the source device, causing the at least one security domain to employ the token generation application to generate the token and to output the generated token to the processing circuitry;
outputting from the source device the token in association with transmitted data generated by the processing circuitry; and
causing the destination device to employ an authentication device to authenticate the transmitted data, the authentication device being responsive to receipt of the token transmitted with the data to the destination device to perform a token generation process to generate a compare token using at least the secret data, and to compare the compare token with the transmitted token to determine whether the transmitted data is to be treated as valid data by the destination device.

27. A device comprising:
a communication interface to transmit data over a wireless network to a destination device;
processing circuitry to generate the data to be transmitted via the communication interface; and
a security module providing a dedicated security domain to store secret data and to provide a token generation application that is executed within the dedicated security domain to generate a token using at least the secret data, the security module further providing a plurality of other security domains, each other security domain to host a profile, and the profile of an enabled other security domain facilitating access by the device to the wireless network;
wherein:
the dedicated security domain is responsive to a request from the processing circuitry to employ the token generation application to generate the token and to output the generated token to the processing circuitry, irrespective of the currently enabled other security domain; and
the processing circuitry is arranged to output the token in association with the transmitted data, enabling authentication of the transmitted data to be performed.

28. A device as claimed in claim 27, wherein the token generation application is downloadable to the dedicated security domain.

29. A device as claimed in claim 27, wherein the secret data is downloadable to the dedicated security domain.

30. A device as claimed in claim 27, wherein the security module further comprises a profile control element to control which of the plurality of other security domains is the enabled other security domain, and the dedicated security domain is arranged to continue to service each request from the processing circuitry for a token, irrespective of any change to the enabled other security domain made by the profile control element.

31. A device as claimed in claim 27, wherein the dedicated security domain comprises an Issuer Security Domain Applet (ISD-A).

32. An authentication device to enable authentication of data transmitted by a device having a dedicated security domain, where the dedicated security domain stores secret data and provides a token generation application that is executed within the dedicated security domain to generate a token using at least the secret data, wherein the authentication device is responsive to receipt of a token transmitted with the data to perform a token generation process to generate a compare token using at least the secret data associated with the dedicated security domain, and to compare the compare token with the transmitted token to determine whether the transmitted data is to be treated as valid data.
